(19) United States
(12) Patent Application Publication
(10) Pub. No.: US 2008/0055107 A1
(43) Pub. Date: Mar. 6, 2008

(54) ALARM DEVICE COMPRISING AN ELECTRONIC FUNDS TRANSFER AT POINT OF SALE TERMINAL AND USE THEREOF

(75) Inventor: David Naccache, Paris (FR)

Correspondence Address: MARSH, FISCHMANN & BREYFOGLE LLP, 3151 SOUTH VAUGHN WAY, SUITE 411, AURORA, CO, 80014, US

(73) Assignee: INGENICO, Neuilly-Sur-Seine (FR)

(21) Appl. No.: 11/847,155

(22) Filed: Aug. 29, 2007

(30) Foreign Application Priority Data
Sep. 1, 2006 (FR) 06 07 686

(51) Int. Cl. H04Q 1/00

(52) U.S. Cl. 340/825

(57) ABSTRACT

An alarm device comprising an electronic funds transfer at point of sale (EFTPOS) terminal is provided, in which the EFTPOS terminal is adapted to be connected to a telecommunications network and comprises a central processing unit and a program, stored in the central processing unit, adapted to send a pre-defined alarm signal via the telecommunications network. Use of the alarm device as a central alarm station is also disclosed.

### BACKGROUND OF THE INVENTION

The present invention relates to an alarm device and a use of this device. Numerous alarm devices and installations are known. Many of them rely on the use of specific modules or devices. For example, French patent application FR-A-2,878,056 discloses a two-way remote control adapted for communication with at least one remote module or item of equipment. As a further example, French patent application FR-A-2,870,624 discloses a small mobile alarm device, made secure using a PIN code, for protecting any location, in the form of a box connected to a mobile phone or to a GSM module or a telephone line.

One problem that arises with known solutions is that they do necessitate an additional investment, when adding these specific modules or devices.

### SUMMARY OF THE INVENTION

The aim of the invention is consequently to provide an alarm device for a merchant or trader which does not involve making additional investments.

The invention provides an alarm device comprising an electronic funds transfer at point of sale (EFTPOS) terminal, in which the EFTPOS terminal is adapted to be connected to a telecommunications network and comprises:

a central processing unit; and

a program, stored in the central processing unit, adapted to send a pre-defined alarm signal via the telecommunications network.

In preferred embodiments, the device according to the invention comprises one or more of the following characteristics:

the pre-defined signal is a pre-defined message.

the message is an SMS message, an MMS message or an e-mail.

the EFTPOS terminal further comprises means for setting off an alarm, the program being adapted to send the pre-defined signal should the said means for setting off an alarm be activated.

the means for setting off an alarm comprise a control device for a manually operated press-button type switch, dedicated to setting off the alarm, or are able to be actuated by pressing a combination of keys on the terminal.

the means for setting off the alarm comprise an accelerometer.

the program is adapted to cause the terminal to operate as a central alarm unit.

the program comprises at least one home automation type functionality.

the program is adapted to send the pre-defined alarm signal should an action relating to the terminal be absent.

The invention also covers the use of the device according to the invention as a central alarm station.

Further characteristics and advantages of the invention will become more clear from reading the description which follows of some embodiments of the invention provided solely by way of example.

### DETAILED DESCRIPTION OF PREFERRED EMBODIMENTS

The invention provides an alarm device comprising an electronic funds transfer at point of sale (EFTPOS) terminal. This terminal can be connected to a telecommunications network, such as the GSM/GPRS network and comprises a central processing unit with a program stored in this central processing unit. The program is adapted to send a pre-defined signal such as a short message (SMS) or a multimedia message (MMS) or an e-mail over the network, for example when means for setting off an alarm provided on the terminal are activated. The solution that the invention provides consequently involves just adapting the functionalities of a point of sale terminal. Such a solution does not require a trader to make an additional investment (EFTPOS terminals being in widespread use in retail stores).

An electronic funds transfer at point of sale (EFTPOS) terminal is a piece of electronic equipment able to register a secure payment transaction. An EFTPOS terminal is typically on the retailer's premises, allowing payments to be made by credit card, such as a smart card or swipe card. The trader introduces the customer's card into a slot in the terminal and enters the amount of the transaction. The customer validates his purchase for example by entering his PIN code on the keyboard of the terminal, and receives a ticket confirming his transaction.

The terminal can optionally be arranged to be connected to management means (for example an electronic cash register), thereby providing point of sale management. The EFTPOS terminal/management means system then constitutes a point of sale (POS) terminal.

The EFTPOS terminal can for example include a portable part for reading smart cards and printing tickets. This part then rests on a base when not in use and communicates with the base by a wireless link, for example radioelectric, when it is being used. The base can be connected to the management means; it typically comprises a modem allowing authorization of the debit from recognized authorization centers.

The EFTPOS terminal according to the invention typically comprises a smart card reader, means for printing a ticket, a modem, and a GSM card. Preferably, the terminal is compatible with the GPRS standard in order to enjoy the benefits of greater bandwidth. Similarly, one can also arrange for the terminal to be compatible with a third generation mobile phone network.

In an alarm situation, the signal sent can for example be an SMS message, an MMS message or an e-mail, for example to a secure PC. Such messages can include pre-defined indications which are specific to the trader and optionally be able to be edited/printed (for example, one or several of the following items of information: date, time, operator present, accessibility, floor, etc.). They are then more readily managed and appropriate measures can be taken.

The alarm can for example be issued manually, automatically, or using an accelerometer module, as will be described below.

Preferably, the terminal includes means for setting off an alarm. The program is in this case adapted to send the pre-defined signal should these means be activated. The alarm can then simply be issued.

The means can typically take the form of a switch of the press-button type for manual operation. Preferably, the button is dedicated to the sole purpose of setting off the alarm, to simplify actuation thereof. A way will then be found of arranging for the button not to be too conspicuous.

The means for setting off the alarm can alternatively take the form of a particular combination of keys on the terminal, which can appropriately be pressed in a given sequence, which optionally can be programmed by the user. This avoids accidentally setting off the alarm.

Other means for setting off the alarm can be envisaged: for example, when the portable part of the terminal is placed in a non-regular fashion on its base, the alarm is set off, optionally after expiry of the timeout and/or an initial warning.

The means for setting off the alarm can further comprise an accelerometer. The accelerometer module then allows particular movements to be detected, which in their turn set off the alarm. Optionally, the accelerometer module can be configured to detect vibrations of the hand, even when the user is standing still. The movement detection threshold can further be adjusted and, additionally, digital signal filtering of the signal from the sensor will make it possible, if needs be, to remove vibrations originating from equipment in the environs (computer, etc.). Such accelerometer modules are available commercially.

Further, the use of an EFTPOS terminal lends itself to positive security measures. In particular, the program can be adapted to send an alarm signal should some action relating to the terminal be absent. For example, and for enhanced security, the fixed part of the terminal (or any other device in the case of a fixed terminal) polls the portable part of the terminal at regular intervals. An acknowledgement signal is then sent by the user from the portable part of the terminal failing which the alarm is set off, optionally after expiry of a timeout. Regular sending of such acknowledgements over the network thus makes it possible, optionally, for a security PC to automatically provide surveillance of the terminal owner, to ensure protection. Such a function is preferably able to be deactivated. When this function is activated, it typically operates in discrete fashion, in other words without any audible or visual manifestation.

Further, the terminal can optionally be coupled to other items of equipment already available on the trader's premises. In this respect, the terminal according to the invention can advantageously operate as a central alarm station, to oversee these items of equipment. Additional investment in a central alarm station is consequently not necessary. In this case, the program can be provided with home automation type functionalities. For example, should the alarm be issued, the doors of the trader's premises can close automatically.

One example of the EFTPOS terminal suitable for implementation in the invention will now be described.

The EFTPOS terminal is provided with a GSM/GPRS communications module (dual band 900/1800 or 900/1900 MHz). Should there be an incident on the GSM/GPRS network, an optional modem can, if needs be, ensure continuous operation.

The EFTPOS terminal is for example fitted with a 32-bit processor handling the usual cryptographic algorithms (RSA, DES, triple DES . . . ). Processor architecture is preferably chosen to allow several applications to operate independently of each other (multi-application and multi-tasking) in the equipment.

In this respect, the above described program can optionally be loaded independently of the other applications provided in the EFTPOS terminal, in order to ensure logic security (or to keep the software “watertight”).

A platform which is particularly suitable for implementing the invention is adapted from Ingenico's UNICAPT 32 platform, built around a 32-bit processor HSC (High Security Core) hardware module including on-board security and a multi-application operating system supporting advanced programming languages such as C, C++ or Java. Such a platform can be integrated into numerous environments:

mobile use with GPRS mobile telephony or Bluetooth;

multi-cash register environments using Ethernet or Wi-Fi with TCP/IP;

high-volume retail outlets using ADSL;

external communication by USB/PCMCIA;

connection to the internet using Wi-Fi hot spots.

This platform can be modified (in particular its configuration program) to allow the features of the invention to be implemented.

The invention is nevertheless not limited to the embodiments described above but may be subject to numerous variations readily accessible to those skilled in the art.

1. An alarm device comprising an electronic funds transfer at point of sale (EFTPOS) terminal, in which the EFTPOS terminal is adapted to be connected to a telecommunications network and comprises:
a central processing unit; and
a program, stored in the central processing unit, adapted to send a pre-defined alarm signal via the telecommunications network.

2. The device according to claim 1, in which the pre-defined signal is a pre-defined message.

3. The device according to claim 1, in which the message is an SMS message, an MMS message or an e-mail.

4. The device according to claim 1, in which the EFTPOS terminal further comprises means for setting off an alarm, the program being adapted to send the pre-defined signal should the said means for setting off an alarm be activated.

5. The device according to claim 4, in which the means for setting off an alarm comprise a device controlling a manually operated press-button type switch, dedicated to setting off the alarm, or are able to be actuated by pressing a combination of keys on the terminal.

6. The device according to claim 4, in which the means for setting off the alarm comprise an accelerometer.

7. The device according to claim 1, in which the program is adapted to cause the terminal to operate as a central alarm station.

8. The device according to claim 7, in which the program comprises at least one home automation type functionality.

9. The device according to claim 1, in which the program is adapted to send the pre-defined alarm signal should an action relating to the terminal be absent.

10. The use of the device according to claim 1, as a central alarm station.
